(19) United States
(12) Patent Application Publication
(10) Pub. No.: US 2023/0053675 A1
(43) Pub. Date: Feb. 23, 2023

(54) SYSTEMS AND METHODS FOR INTERACTIVE CHATBOT AUTHENTICATION OF USERS

(71) Applicant: Mastercard International Incorporated, Purchase, NY (US)

(72) Inventors: David Scott Edwards, Fenton, MO (US); Asha Somayajula, Eureka, MO (US); Seth Kalpathy, Lake Saint Louis, MO (US)

(21) Appl. No.: 17/408,219

(22) Filed: Aug. 20, 2021

(51) Int. Cl. G06F 21/31; H04L 29/06; G06Q 20/40; G06Q 20/38; H04L 12/58

(52) U.S. Cl. CPC G06F 21/31; H04L 63/08; G06Q 20/4016; G06Q 20/386; H04L 51/02; G06F 2221/2113; G06F 2221/2103; G06Q 20/385; G06Q 20/40145

(57) ABSTRACT

A computing system for authenticating users utilizing an interactive chatbot is provided. The computing system includes a processor in communication with a memory, and the processor programmed to: (i) receive an authorization request message for a transaction initiated by a user, wherein the authorization request message includes transaction data, (ii) retrieve user data associated with the user, (iii) determine, based upon the transaction data and the user data, a risk associated with the transaction, (iv) generate, based upon the risk associated with the transaction, one or more prompts for the user, (v) transmit, via the interactive chatbot, the one or more prompts to the user, (vi) receive user input in response to the one or more prompts, and (vii) embed an authentication indicator into the authorization request message, wherein the authentication indicator indicates whether the user is authenticated based upon the user input.

### BACKGROUND

The present application relates generally to authenticating users associated with payment transactions with a chatbot, and more specifically, to authenticating users using an interactive chatbot that intuitively and creatively verifies the users.

In known payment systems, no authentication processes including an interactive chatbots that intuitively and creatively authenticate users for different transaction types (e.g., electronic transactions, card-not-present transaction, etc.) are provided. Accordingly, there is a need for such authentication processes.

### BRIEF DESCRIPTION

In one aspect, a computing system for authenticating users utilizing an interactive chatbot is provided. The computing system includes at least one processor in communication with at least one memory, and the at least one processor is programmed to: (i) receive an authorization request message for a transaction initiated by a user, wherein the authorization request message includes transaction data, (ii) retrieve, from the at least one memory, user data associated with the user, (iii) determine, based upon the transaction data and the user data, a risk associated with the transaction, (iv) generate, based upon the risk associated with the transaction, one or more prompts for the user, (v) transmit, via the interactive chatbot, the one or more prompts to the user, (vi) receive user input in response to the one or more prompts, and (vii) embed an authentication indicator into the authorization request message, wherein the authentication indicator indicates whether the user is authenticated based upon the user input.

In another aspect, a computer-implemented method for authenticating users utilizing an interactive chatbot is provided. The method includes: (i) receiving an authorization request message for a transaction initiated by a user, wherein the authorization request message includes transaction data, (ii) retrieving, from the at least one memory, user data associated with the user, (iii) determining, based upon the transaction data and the user data, a risk associated with the transaction, (iv) generating, based upon the risk associated with the transaction, one or more prompts for the user, (v) transmitting, via the interactive chatbot, the one or more prompts to the user, (vi) receiving user input in response to the one or more prompts, and (vii) embedding an authentication indicator into the authorization request message, wherein the authentication indicator indicates whether the user is authenticated based upon the user input.

In yet another aspect, at least one non-transitory computer-readable storage media including computer-executable instructions for authenticating users utilizing an interactive chatbot is provided. When executed by a computing system including at least one processor in communication with at least one memory, the computer-executable instructions cause the at least one processor to: (i) receive an authorization request message for a transaction initiated by a user, wherein the authorization request message includes transaction data, (ii) retrieve, from the at least one memory, user data associated with the user, (iii) determine, based upon the transaction data and the user data, a risk associated with the transaction, (iv) generate, based upon the risk associated with the transaction, one or more prompts for the user, (v) transmit, via the interactive chatbot, the one or more prompts to the user, (vi) receive user input in response to the one or more prompts, and (vii) embed an authentication indicator into the authorization request message, wherein the authentication indicator indicates whether the user is authenticated based upon the user input.

### BRIEF DESCRIPTION OF THE DRAWINGS

FIGS. 1-7 show example embodiments of the methods and systems described herein.

FIG. 1 is a schematic diagram illustrating an example multi-party payment account system for enabling payment transactions with an interactive chatbot (IC) computing device for authenticating users and authorizing transactions in accordance with one embodiment of the present disclosure.

FIG. 2 is a block diagram of an example embodiment of an interactive chatbot (IC) platform including the IC computing device shown in FIG. 1.

FIG. 3A is a data flow diagram showing an example flow of data within the IC platform of FIG. 2.

FIGS. 3B-3D are data flow diagrams showing example flows of data for different transaction types within the data flow diagram shown in FIG. 3A.

FIG. 4 is an example configuration of a client system shown in FIG. 2.

FIG. 5 is an example configuration of a server system shown in FIG. 2.

FIG. 6 is a diagram of components of one or more example computing devices that may be used in the IC platform shown in FIG. 2.

FIG. 7 is a simplified diagram of an example method for authenticating users using the IC computing device of FIG. 1.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION

The systems and methods described herein are directed to authenticating users utilizing an interactive chatbot. In one example embodiment, the systems and methods may be performed by an interactive chatbot (IC) computing device. The IC computing device may be in communication with a payment processor, one or more issuers, one or more merchants, and one or more users.

The IC computing device authenticates users for a variety of different transaction types (e.g., electronic transactions, card-not-present transactions, and/or card-not-present but user-device-present transactions) initiated by the users. In authenticating a user, the IC computing device receives, from a payment processor and/or an issuer device, user data and historical transaction data, and the received data is utilized to intuitively and creatively authenticate the users using an interactive chatbot at the point of sale. The interactive chatbot generates prompts using machine learning and/or artificial intelligence techniques based upon the received data, and transmits the prompts to the user through a user computing device or a merchant system (e.g., a point of sale device).

If the user correctly and accurately answers the prompts, the IC computing device authenticates the user and transmits the transaction to a payment processor for further processing. However, if the user incorrectly and inaccurately answers the prompts, the IC computing device generates additional prompts for the user to answer. The additional prompts may have a higher difficulty and/or require higher accuracy than the initial prompts. If the user correctly and accurately answers the additional prompts, the IC computing device authenticates the user. If the user incorrectly and inaccurately answers the additional prompts, the IC computing device, either itself or on behalf of a payment processor/issuer, declines authorization for the transaction.

Since the IC computing device can be used to authenticate users for a variety of transactions, the IC computing device provides freedom for users to carry out a variety of transactions while protecting merchants and issuers from processing transactions carried out by a fraudulent user.

The technical problems addressed by the disclosure include at least one of: (i) lack of interactive chatbot having access to user data and historical transaction data to authenticate users, (ii) inability to interactively and securely authenticate users in card-not-present transactions, (iii) slow authentication speeds, and (iv) lack of an engaging authentication process.

The resulting technical benefits and effects achieved by the systems and methods of the disclosure include at least one of: (i) providing an interactive chatbot having access to user data and historical transaction data to authenticate users, (ii) interactively authenticating users in card-not-present transactions, (iii) increased authentication speeds, (iv) providing an engaging authentication process, and (v) conservation of processing resources due to a reduced number of fraudulent transactions being processed.

The methods and systems directed to the IC computing device described herein may be implemented using computer programming or engineering techniques including computer software, firmware, hardware or any combination or subset thereof, wherein the technical effect may be achieved by performing at least one of the following steps: (i) receiving an authorization request message for a transaction initiated by a user, wherein the authorization request message includes transaction data, (ii) retrieving, from the at least one memory, user data associated with the user, (iii) determining, based upon the transaction data and the user data, a risk associated with the transaction, (iv) generating, based upon the risk associated with the transaction, one or more prompts for the user, (v) transmitting, via the interactive chatbot, the one or more prompts to the user, (vi) receiving user input in response to the one or more prompts, and (vii) embedding an authentication indicator into the authorization request message, wherein the authentication indicator indicates whether the user is authenticated based upon the user input.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an IOS® environment (IOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In an additional embodiment, the system is run on an iOS® environment (iOS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality. The following detailed description illustrates embodiments of the disclosure by way of example and not by way of limitation. It is contemplated that the disclosure has general application to providing an interactive chatbot for authenticating users.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PCAs), and key fobs.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database implementation (e.g., relational, document-based) may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, transaction data includes any account, transaction, merchant, issuer, authorization, and/or clearing data associated with a transaction. Transaction data may include account identifiers (e.g., payment account numbers (PANs), bank identifier numbers (BINs), etc.), account information (e.g., whether accounts are in good standing or bad standing), payment card types, transaction amounts, item identifiers, merchant identifiers, merchant locations, merchant category codes, issuing bank, authorization messages, clearing messages, transaction identifiers, etc.

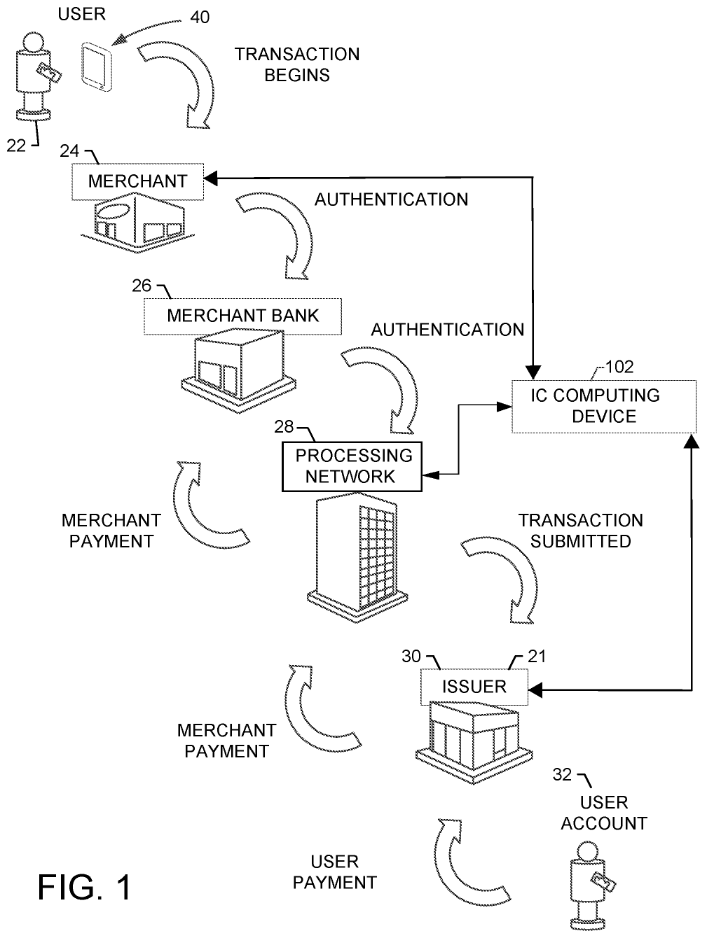

FIG. 1 illustrates a schematic diagram of an example multi-party payment account system for enabling payment transactions initiated by cardholders (e.g., user 22) over a payment processing network 28 that is in communication with an interactive chatbot (IC) computing device 102. IC computing device 102 is configured to collect transaction data from a merchant 24, authenticate user 22 through the use of an interactive chatbot, and, once user 22 has been authenticated, transmit an authentication message to payment processing network 28 (e.g., an interchange network 28) for further processing of the transaction. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, IC computing device 102 is communicatively coupled to merchant 24, processing network 28, and an issuer 30. As used herein, merchant 24 and issuer 30 may be directly connected to IC computing device 102, or may be indirectly connected to IC computing device 102 through payment processing network 28.

In the exemplary embodiment, a financial institution called the “issuer” or “issuing bank” issues an account, such as a credit card account, a debit account, or a prepaid card account to cardholder 22, who uses the account to tender payment for a purchase from a merchant 24. In one embodiment, cardholder 22 presents a payment card and/or a digital wallet to merchant 24 using a user computing device (also known as card-present transactions). In another embodiment, the user does not present a physical payment device, and instead performs a card-not-present transaction. For example, the card-not-present transaction may be initiated via a digital wallet application, through a website or web portal, via telephone, or any other method that does not require the user to present a physical payment card to merchant 24 (e.g., via swiping or inserting the payment card and/or scanning the digital wallet).

To accept payment with the transaction card, merchant 24 establishes an account with a financial institution that is part of the financial payment system. This financial institution is usually called the “merchant bank,” the “acquiring bank,” or the “acquirer.” In one embodiment, cardholder 22 tenders payment for a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads account information of cardholder 22 from a magnetic stripe, a chip, barcode, or embossed characters on the transaction card (e.g., a debit card or a prepaid card) and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

In the example embodiment, merchant 24 communicates with, either directly or indirectly via processing network 28, IC computing device 102 to authenticate cardholder 22 before the transaction is further processed. IC computing device 102 authenticates cardholder 22 as described herein. Once cardholder 22 has been authenticated, using processing network 28, computers of merchant bank 26 or merchant processor will communicate with computers of an issuer bank 30 to determine whether an account 32 of cardholder 22 is in good standing and whether the purchase is covered by an available credit line of cardholder 22. Based on these determinations, the request for authorization will be declined or accepted. If the request is accepted, an authorization code (e.g., included in an authorization message) is issued to merchant 24. Authorization message 50 includes a transaction identifier associated with the transaction and an indicator indicating that the transaction was authorized. If the request is not accepted, authorization message includes a transaction identifier associated with the transaction and an indicator indicating that the transaction was declined. In the example embodiment, authorization message is formatted according to ISO 8583 network messaging protocol or the equivalent messaging protocol used by the payment card processing network.

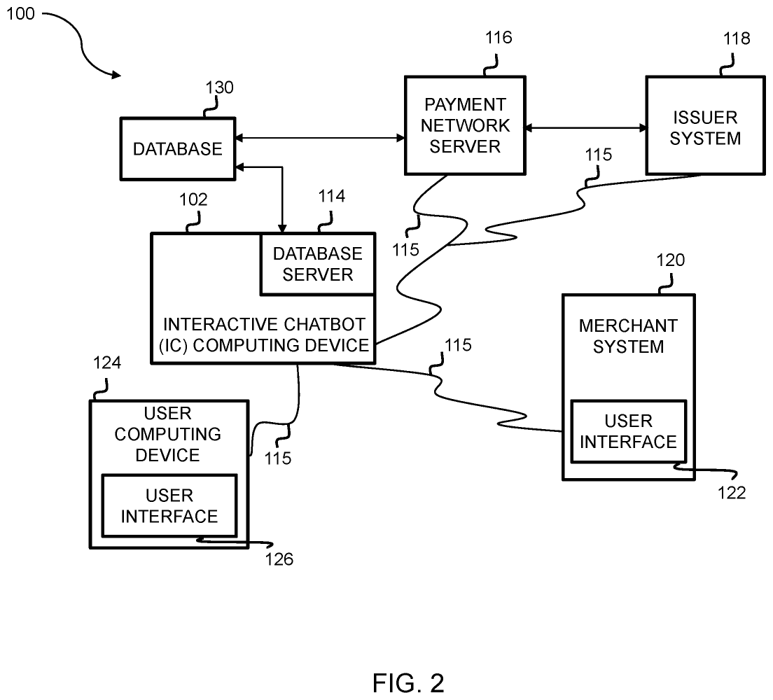

When a request for authorization is accepted, the available credit line of account 32 of cardholder 22 is decreased. Normally, a charge for a payment card transaction is not posted immediately to account 32 of cardholder 22 because certain rules do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Processing network 28 and/or issuer bank 30 stores the transaction card information, such as a type of merchant, amount of purchase, date of purchase, etc. in a database 130 (shown in FIG. 2).

After a purchase has been made, a clearing process occurs to transfer additional transaction data related to the purchase among the parties to the transaction, such as merchant bank 26, processing network 28, and issuer bank 30. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 24, merchant bank 26, and issuer bank 30. Settlement refers to the transfer of financial data or funds among account of merchant 24, merchant bank 26, and issuer bank 30 related to the transaction. Usually, transactions are captured and accumulated into a “batch,” which is settled as a group. More specifically, a transaction is typically settled between issuer bank 30 and processing network 28, and then between processing network 28 and merchant bank 26, and then between merchant bank 26 and merchant 24.

As described above, the various parties to the payment card transaction include one or more of the parties shown in FIG. 1 such as, for example, cardholder 22, merchant 24, merchant bank 26, processing network 28 (also referred to herein as payment processor 28), issuer bank 30, and/or an issuer processor 21.

FIG. 2 is an expanded block diagram of an example embodiment of an interactive chatbot platform 100 used in authenticating users that includes interactive chatbot (IC) computing device 102 in accordance with one example embodiment of the present disclosure. In the example embodiment, platform 100 is used for authenticating users once transactions are initiated, as described herein.

More specifically, in the example embodiment, platform 100 includes IC computing device 102, and a plurality of client sub-systems connected to IC computing device 102. Client sub-systems include issuer system 118 (also referred to as issuer computing device 118), merchant system 120 (also referred to as merchant computing device 120), and a user computing device 124 (also referred to as user system 124). In one embodiment, client sub-systems 118, 120, 124 are computers including a web browser, such that IC computing device 102 is accessible to client sub-systems 118, 120, 124 using the Internet and/or using network 115. Client sub-systems 118, 120, 124 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Issuer system 118 includes systems associated with issuer banks 30 (shown in FIG. 1) as well as external systems used to store data. Merchant system 120 includes systems associated with merchants 24 (shown in FIG. 1) as well as external systems used to store data. For example, merchant system 120 may be a POS device communicatively couple to an external system of merchants 24. User computing device 124 includes systems associated with cardholders 22 (shown in FIG. 1) as well as external systems used to store data. IC computing device 102 is also in communication with a payment network server 116 (also referred to as a payment processing network 116) associated with interchange network 28 (shown in FIG. 1) using network 115. Further, client sub-systems 118, 120, 124 may additionally communicate with interchange 28 using network 115. Client sub-systems 118, 120, 124 could be any device capable of interconnecting to the Internet including a web-based phone, PDA, or other web-based connectable equipment.

A database server 114 is connected to database 130, which contains information on a variety of matters, as described below in greater detail. In one embodiment, centralized database 130 is stored on IC computing device 102 and can be accessed by potential users at one of client sub-systems 118, 120, 124 by logging onto IC computing device 102 through one of client sub-systems 118, 120, 124. Access to centralized database 130 is controlled by IC computing device 102 to limit the display of data to authorized users enrolled with IC computing device 102. In an alternative embodiment, database 130 is stored remotely from IC computing device 102 and may be non-centralized. Database 130 may be a database configured to store information used by IC computing device 102 including, for example, current transaction data, prompt data, user data, historical transaction data, merchant data, and/or other data.

Database 130 may include a single database having separated sections or partitions, or may include multiple databases, each being separate from each other. In some embodiments, database 130 stores transaction data generated over the processing network including data relating to merchants, consumers, account holders, prospective customers, issuers, acquirers, and/or purchases made.

In the example embodiment, merchant system 120 includes a user interface 122, and user computing device 124 includes a user interface 126. User interfaces 122, 126 may include a graphical user interface with interactive functionality, such that cardholders 24 may answer or respond to prompts from IC computing device 102 to be authenticated by IC computing device 102. That is, users of user interfaces 122, 126 can interactively answer or response to prompts from IC computing device 102, and input from the users of user interfaces 122, 126 is transmitted to IC computing device 102. IC computing device 102 may be supported by interchange network 28 and/or may process transaction data.

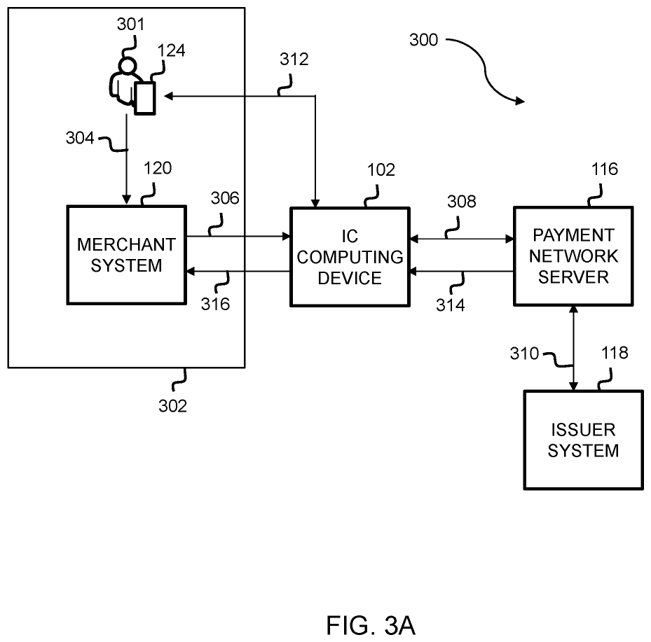

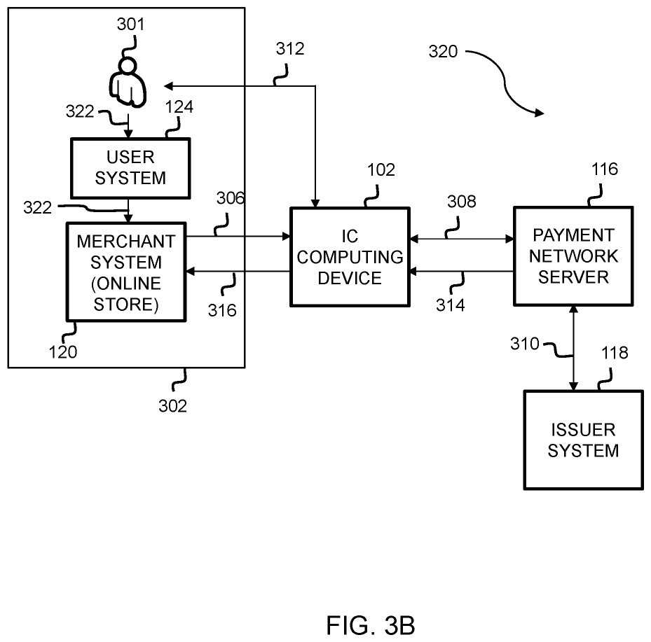

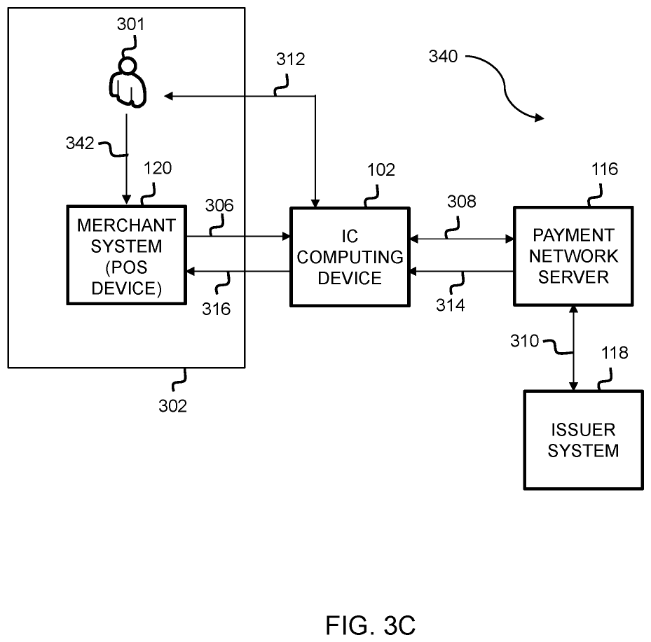

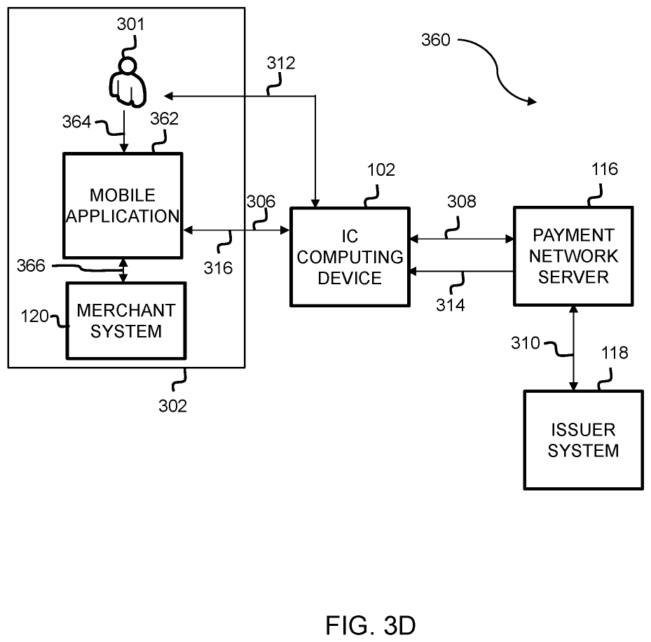

FIG. 3A is a data flow diagram 300 showing an example flow of data within IC platform 100 (shown in FIG. 2), and FIGS. 3B-3D are data flow diagrams 320, 340, and 360 showing example flows of data for different transaction types within diagram 300 in accordance with example embodiments of the present disclosure. That is, FIG. 3A illustrates a high-level flow of data, and FIGS. 3B-3D show additional data flows for different transaction types (e.g., online transactions, card and user computing device not present transactions, and card not present transactions).

Diagram 300 illustrates a high-level flow of data for all transactions processed in associated with IC platform 100 (shown in FIG. 2). A user 301 associated with user computing device 124 initiates 302 a transaction with merchant system 120. To initiate 302 the transaction, user 301 transmits payment information 304 to merchant system 120. Merchant system 120 is in communication with IC computing device 102 and transmits an authorization request message 306 to IC computing device 102 to initiate the authorization of the transaction by first authenticating user 301. In the exemplary embodiment, authorization request message 306 includes transaction data (i.e., any data associated with the transaction including a payment account identifier and/or a user identifier, a merchant identifier, a transaction amount, a transaction location, etc.).

IC computing device 102 is in communication with payment network server 116 and issuer system 118. To authenticate user, IC computing device 102 requests user data 308 specific to user 301 from payment network server 116. User data 308 includes historical transaction data of user 301. From user data 308, IC computing device 102 is able to determine transaction trends, common transactions, reoccurring transactions, unique transactions, typical transaction limits, etc. for user 301. IC computing device 102 determines, from a database (e.g., database 130 shown in FIG. 2) associated with IC computing device 102, a user 301 and corresponding user identifier by performing a look-up in the database for the user and the corresponding user identifier associated with the transaction data included in authorization request message 306. In some embodiments, the transaction data includes a payment account identifier that can identify the user and user identifier. In other embodiments, like for card-not-present transactions, the transaction data includes a username/password or token that can identify the user and user identifier. IC computing device 102 transmits the user identifier to payment network server 116 in a request (e.g., a query) for user data associated with user 301. In other embodiments, IC computing device 102 transmits the payment account identifier to payment network server 116, and payment network server 116 determines user 301 and corresponding user identifier associated with the payment account identifier.

Further, IC computing device 102, either alone or together with payment network server 116, determines a risk associated with the transaction based upon the transaction data included in authorization request message and/or user data 308, as described in further detail below. Higher risks are associated with transactions that have a higher likelihood of being fraudulent and/or disputable and transactions carried out at merchants known to have a high rate of fraudulent transactions. Lower risks are associated with transactions that have a lower likelihood of being fraudulent and/or disputable and transactions carried out at merchants known to have low rates of disputable transactions. Due to the risk associated with higher risk transactions, users 301 that initiate higher risk transactions require more secure and challenging authentication than users 301 that initiate lower risk transactions. For higher risk transactions, more specific and in-depth data may be needed for IC computing device 102 to thoroughly authenticate users 301 associated with the higher risk transactions. Accordingly, IC computing device 102 and/or payment network server 116 requests and receives in-depth user data 310 from issuer system 118 (e.g., of the issuer that issues the payment account associated with the transaction). In-depth user data 310 includes, address, phone number, email, social security number, credit history, and other user-specific account information in which issuer system 118 has access.

Using user data 308 and/or in-depth user data 310 and machine learning or artificial intelligence techniques, IC computing device 102 generates and transmits prompts 312 to user computing device 124 of user 301 or a user interface of merchant system 120 based upon the risk associated with the transaction. Harder prompts 312 are transmitted for higher-risk transactions, and easier prompts 312 are transmitted for lower-risk transactions. Prompts 312 are structured in a variety of different ways including short answer questions where user 301 inputs answers to prompts using a keypad or number pad of user device 124 and/or a user interface of merchant system 120 or multiple choice prompts 312 where user 301 picks a correct choice from two or more options. For example, easier prompts 312 may include questions including “Where did you eat lunch yesterday?” “How much did you spend at Merchant A last night?” “Who is your cell phone provider?” “What gym do you have a membership at?” etc. Harder prompts 312 may include questions including “You made an abnormally large purchase last week—what store was it made at?” “What are the last four digits of your social security number?” “What is your mother's maiden name?” etc. Further, for example, easier prompts 312 may include a prompt with two or three multiple choice answers when harder prompts 312 may include a short answer prompt.

Based upon responses of user 301 to prompts 312, IC computing device 102 determines whether user 301 is authenticated, whether user 301 requires additional, harder prompts 312 to be authenticated, or whether user 301 is not authenticated. Further, IC computing device 102 assigns a risk score to each response based upon how accurate the response of user 301 is. Responses with high accuracy (e.g., response is the correct answer of a multiple choice prompt or response is a highly accurate short answer response) are assigned a low risk score while responses with low accuracy (e.g., response is the incorrect answer of a multiple choice prompt or response is an inaccurate short answer response) are assigned a high risk score. For example, if prompt 312 is “How much did you spend on lunch yesterday?” user 301 answers “$7,” and the correct answer, as determined by IC computing device 102, is $6.83, IC computing device 102 would assign a low risk score to the answer because the answer is mostly accurate. However, if prompt 312 is “How much did you spend on lunch yesterday?” user 301 answers “$15,” and the correct answer is $6.83, IC computing device 102 would assign a high risk score to the answer because the answer is inaccurate. Thresholds for accuracy of prompts 312 may be determined by merchants, IC computing device 102, payment processor 28, and/or issuers.

If IC computing device 102 assigns one or more responses of user 301 with a high risk score, IC computing device 102 generates and transmits additional, more difficult prompts 312 for user 301 to answer. If user 301 answers the additional prompts correctly and a low risk score is assigned to the answers of additional, more difficult prompts 312, IC computing device 102 authenticates user 301. If user 301 answers the additional prompts incorrectly and again has a high risk score assigned to the answers of the additional, more difficult prompts 312, IC computing device 102, declines authentication of user 301, and/or embeds the high risk score in a signal to issuer system 118. Further, when IC computing device 102 declines authentication of user 301, or issuer system 118 responds to the high risk score embedded by IC computing device 102, the transaction initiated 304 by user 301 is declined, either by issuer system 118 or by IC computing device 102 configured to act on behalf of issuer system 118 in response to a declined authentication.

When user 301 is authenticated, IC computing device 102 receives additional payment information 314 from payment network server 116. For example, additional payment information may include a payment account identifier (e.g., for card-not-present transactions) including payment token numbers, expiry date, CVC, address, etc. Additional payment information 314 is securely transmitted to IC computing device 102 without further user 301 involvement.

IC computing device 102 embeds an authentication indicator (e.g., indicating that user 301 is authenticated) and any necessary additional payment information 314 to merchant system 120 to complete authorization of the transaction for the merchant. Further, IC computing device 102 transmits all authentication data to payment processor server 116 for further processing (e.g., clearing and transferring of funds).

FIG. 3B illustrates data flow diagram 320 showing an example flow of data within IC platform 100 (shown in FIG. 2) for an electronic transaction. Data flow diagram 320 is substantially similar to data flow diagram 300 except that data flow diagram 320 shows additional detail of how user 301 initiates 302 the electronic transaction. User 301 browses an online merchant through user system 124. Once user 301 is ready to check out (e.g., to initiate 302 the electronic transaction), user 301 enters preferred payment method 322 into user system 124, and user system 124 transmits payment method 322 to the online merchant system 120. Online merchant store 120 then interacts with IC computing device 102 to authenticate user 301 and authorize the electronic transaction.

FIG. 3C illustrates data flow diagram 340 showing an example flow of data within IC platform 100 (shown in FIG. 2) for a card-not-present transaction where user 301 is authenticated through a point of sale (POS) device of merchant system 120. That is, data flow diagram 340 shows an example data flow when user 301 does not have their payment card to start a transaction at a merchant. Data flow diagram 340 is substantially similar to data flow diagram 300 except that data flow diagram 340 shows additional detail of how user 301 initiates 302 the card-not-present transaction. Using POS device 120, user 301 enters either a payment account identifier 342 (e.g., a credit card number) or a username 342 to POS device 120 to initiate 302 the card-not-present transaction. IC computing device 102 determines the user 301 associated with payment account identifier 342 and/or username 342, and authenticates the user as shown in data flow diagram 300. IC computing device 102 may determine that card-not-present transactions are riskier and generate and transmit difficult prompts 312 to user 301 through POS device 120. However, user 301 is still able to carry out the transaction because of IC computing device 102 and the interactive authentication of IC computing device.

FIG. 3D illustrates data flow diagram 360 showing an example flow of data within IC platform 100 (shown in FIG. 2) for a card-not-present but user computing device 124 present transaction. Data flow diagram 360 is substantially similar to data flow diagram 300 except that data flow diagram 360 shows additional detail of how user 301 initiates 302 the transaction. As in data flow diagram 340, user 301 initiates 302 the transaction without a payment card and by inputting either a payment account identifier 364 (e.g., a credit card number) or a username 364. However, in data flow diagram 360, POS device 120 does not support the interactive chatbot of IC computing device 102, so user computing device 124 (e.g., including mobile application 362 thereon) is present and used to authenticate user 301. That is, user computing device 124 and application 362 interact with IC computing device 102 and authenticate user 301 on behalf of IC computing device 102. User 301 receives prompts 312 through application 362. Once user 301 is authenticated by IC computing device 102, application 362 transmits transaction details (e.g., authorization message including authentication indicator) to POS device 102.

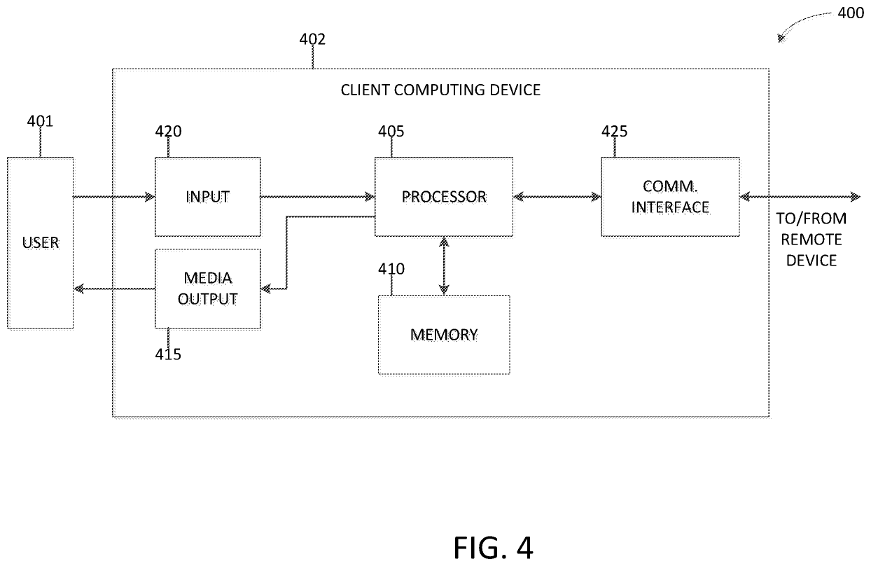

FIG. 4 illustrates an example configuration of a client computing device 402. Client computing device 402 may include, but is not limited to, merchant system 120 and/or user computing device 124 (shown in FIG. 2). Client computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Client computing device 402 also includes at least one media output component 415 for presenting information to a user 401 (e.g., cardholder 22, shown in FIG. 1). Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 415 and input device 520.

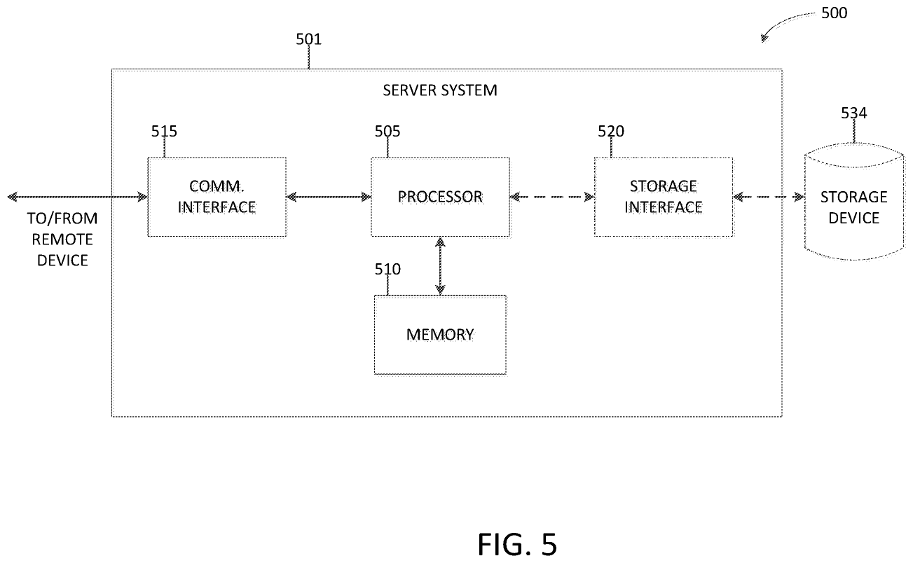

Client computing device 402 may also include a communication interface 425, which is communicatively countable to a remote device such as a server system (e.g., server system 501 shown in FIG. 5) or a web server. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable users 401 to display and interact with media and other information typically embedded on a web page or a website from a web server. A client application allows users 401 to interact with a server application associated with, for example, IC computing device 102. The user interface, via one or both of a web browser and a client application, facilitates displaying prompts generated by IC computing device 102. The user may interact with the user interface to view and respond to prompts using input device 420.

FIG. 5 illustrates an example configuration of a server (host computing device) system 501 such as IC computing device 102, payment network server 116, and/or issuer system 118 (shown in FIG. 2) used to receive transaction data associated with payment transactions and authenticate users of the payment transactions using an interactive chatbot.

Server system 501 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 501, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 501 is capable of communicating with a remote device such as another server system 501. For example, communication interface 515 may receive requests from payment network server 116 and/or issuer system 118 via the Internet, as illustrated in FIG. 2.

Processor 505 may also be operatively coupled to a storage device 534. Storage device 534 is any computer-operated hardware suitable for storing and/or retrieving data. In some embodiments, storage device 534 is integrated in server system 501. For example, server system 501 may include one or more hard disk drives as storage device 534. In other embodiments, storage device 534 is external to server system 501 and may be accessed by a plurality of server systems 501. For example, storage device 534 may include multiple storage units such as hard disks or solid state disks in a redundant array of inexpensive disks (RAID) configuration. Storage device 534 may include a storage area network (SAN) and/or a network attached storage (NAS) system. In some embodiments, server system 501 also includes database server 114 (shown in FIG. 2).

In some embodiments, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

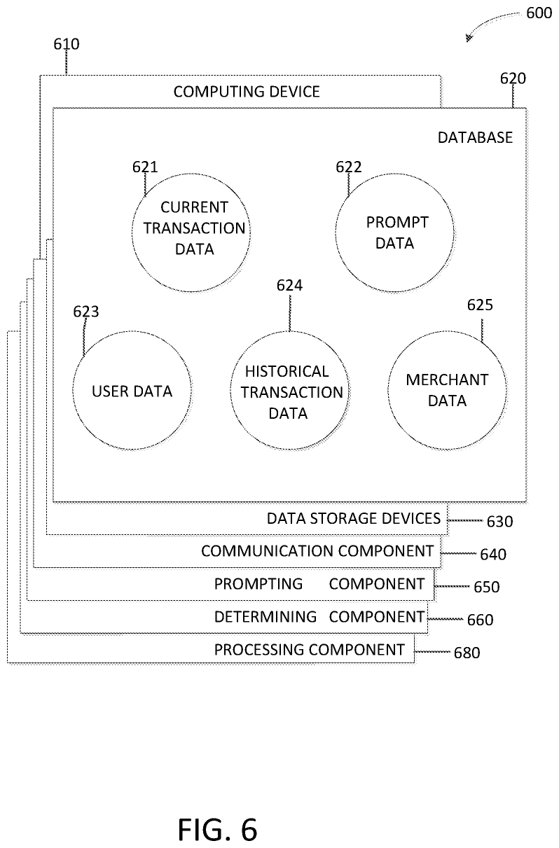

FIG. 6 is a diagram of components 600 of one or more example computing devices 610 (e.g., IC computing device 102) that may be used in the environment shown in FIG. 2. Computing device 610 includes database 620 as well as data storage devices 630, a communication component 640, a prompting component 650, a determining component 660, and a processing component 680. Database 620 may store information such as, for example, current transaction data 621, prompt data 622, user data 623, historical transactions data 624 and merchant data 625. For example, current transaction data 621 includes data related to transactions currently being processed by payment processing network 28 and/or payment network server 116, prompt data 622 includes language elements, rules, and/or model parameters used to generate the prompts as discussed above, user data 623 includes user data 308 and/or in-depth user data 310, historical transaction data 624 includes data related to transactions previously processed by one or more payment processing networks such as payment processing network 28, and merchant data 625 includes data relating to various merchants registered to submit transactions for authorization via payment processing network 28. Database 620 is coupled to several separate components within IC computing device 102, which perform specific tasks. In some embodiments, database 620 is substantially similar to database 130 (shown in FIG. 2).

Communication component 640 facilitates communication between computing device 610 and other systems (e.g., payment network server 116 and/or issuer system 118, as shown in FIG. 2). Prompting component 650 is used to generate one or more prompts provided by the interactive chatbot to the user based upon the risk associated with the transaction. Determining component 660 is used to determine a risk associated with transactions. Processing component 680 processes data and performs other steps as described herein.

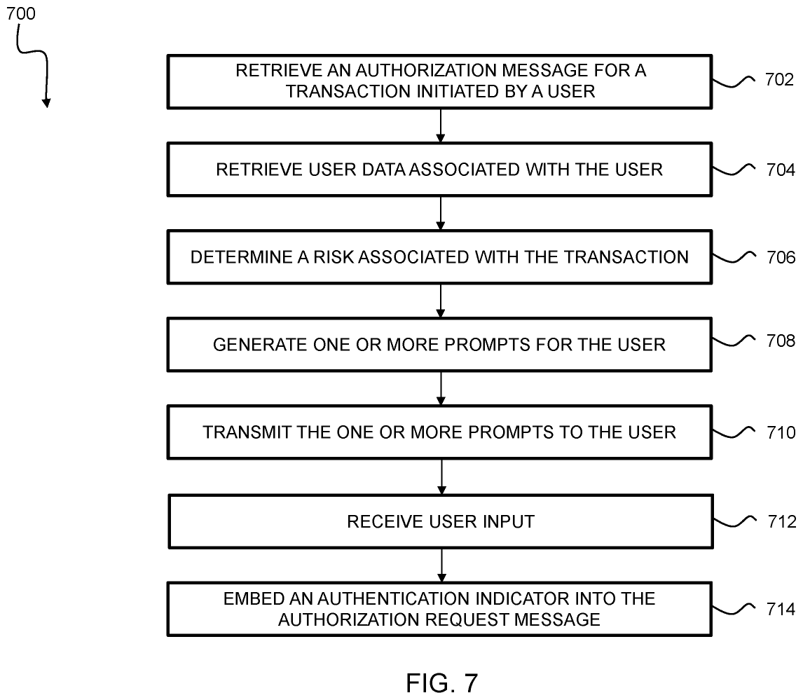

FIG. 7 illustrates a flow chart of an exemplary method 700 for authenticating users using an interactive chatbot. Method 700 may be carried out by interactive chatbot (IC) computing device 102 (shown in FIG. 2).

In the exemplary embodiment, method 700 includes retrieving 702 an authorization message for a transaction initiated by a user. The authorization request message includes transaction data. The method further includes retrieving 704, from a memory, user data associated with the user. Based upon the transaction data and the user data, a risk associated with the transaction is determined 706.

Method 700 further includes generating 708 one or more prompts for the user based upon the risk associated with the transaction, and the one or more prompts are transmitted 710 to the user via the interactive chatbot. User input in response to the one or more prompts is received 712, and an authentication indicator is embedded 714 into the authorization request message. The authentication indicator indicates whether the user is authenticated based upon the user input to the one or more prompts.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, computer-executable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of fraud analysis for registration of merchants with acquirer banks. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the verification computing module are described herein as including general processing and memory devices, it should be understood that the verification computing module is a specialized computer configured to perform the steps described herein for verifying operation of payment terminals and payment processing networks.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A computing system for authenticating users utilizing an interactive chatbot, the computing system comprising at least one processor in communication with at least one memory, the at least one processor programmed to:
receive an authorization request message for a transaction initiated by a user, wherein the authorization request message includes transaction data;
retrieve, from the at least one memory, user data associated with the user;
determine, based upon the transaction data and the user data, a risk associated with the transaction;
generate, based upon the risk associated with the transaction, one or more prompts for the user;
transmit, via the interactive chatbot, the one or more prompts to the user;
receive user input in response to the one or more prompts; and
embed an authentication indicator into the authorization request message, wherein the authentication indicator indicates whether the user is authenticated based upon the user input.

2. The computing system of claim 1, wherein the at least one processor is further programmed to:
compare the user input and the received user data;
determine, based upon the comparison, a risk score for the user input, wherein the risk score indicates an accuracy level of the user input;
determine, based upon the comparison, an assurance level for the user input, wherein the assurance level indicates an authentication level for the user based upon at least one the risk score and a difficulty level of the one or more prompts; and
embed the assurance level into the authorization request message.

3. The computing system of claim 2, wherein the at least one processor is further programmed to:
receive, from one or more issuer computing devices, a predetermined threshold indicating a minimum risk score for the user to be authenticated;
store, in the at least one memory, the predetermined threshold; and
authenticate the user based upon the user having a risk score above the predetermined threshold.

4. The computing system of claim 3, wherein the at least one processor is further programmed to:
generate, when the user has a risk score below the predetermined threshold, one or more additional prompts for the user, wherein the one or more additional prompts have a higher difficulty level than the difficulty level of the initial prompts;
transmit, via the interactive chatbot, the one or more additional prompts to the user;
receive additional user input in response to the one or more additional prompts;
determine the risk score of the additional user input;
authenticate the user based upon the user having a risk score for the additional user input above the predetermined threshold; and
decline authenticating the user based upon the user having a risk score for the additional user input below the predetermined threshold.

5. The computing system of claim 1, wherein the at least one processor to be further programmed to:
generate one or more low difficulty prompts for the user based upon the risk associated with the transaction being low; and
generate one or more high difficulty prompts for the user based upon the risk associated with the transaction being high.

6. The computing system of claim 1, wherein the at least one processor is further programmed to:
utilize at least one of a machine learning algorithm and an artificial intelligence algorithm to generate the one or more prompts for the user, wherein the generated prompts are specific to the user based upon the user data.

7. The computing system of claim 1, wherein the at least one processor is further programmed to:
transmit the embedded authorization request message to a payment processing network for further processing of the transaction.

8. The computing system of claim 1, wherein the transaction data is received from a merchant computing device and includes a payment account identifier, a merchant identifier, a transaction amount, and a transaction location, wherein the user data is received from at least one of a user computing device and an issuer computing device and includes a user address, transaction history, and previous fraudulent activity, and wherein the one or more prompts include user-specific questions based upon the user data, requests for biometric data, and a one-time use code sent to the user computing device.

9. A computer-implemented method for authenticating users using an interactive chatbot, the method implemented by a computing system including at least one processor in communication with at least one memory, the method comprising:
receiving an authorization request message for a transaction initiated by a user, wherein the authorization request message includes transaction data;
retrieving, from the at least one memory, user data associated with the user;
determining, based upon the transaction data and the user data, a risk associated with the transaction;
generating, based upon the risk associated with the transaction, one or more prompts for the user;
transmitting, via the interactive chatbot, the one or more prompts to the user;
receiving user input in response to the one or more prompts; and
embedding an authentication indicator into the authorization request message, wherein the authentication indicator indicates whether the user is authenticated based upon the user input.

10. The computer-implemented method of claim 9 further comprising:
comparing the user input and the received user data;
determining, based upon the comparison, a risk score for the user input, wherein the risk score indicates an accuracy level of the user input;
determining, based upon the comparison, an assurance level for the user input, wherein the assurance level indicates an authentication level for the user based upon at least one the risk score and a difficulty level of the one or more prompts; and
embedding the assurance level into the authorization request message.

11. The computer-implemented method of claim 10 further comprising:
receiving, from one or more issuer computing devices, a predetermined threshold indicating a minimum risk score for the user to be authenticated;
storing, in the at least one memory, the predetermined threshold; and
authenticating the user based upon the user having a risk score above the predetermined threshold.

12. The computer-implemented method of claim 11 further comprising:
generate, when the user has a risk score below the predetermined threshold, one or more additional prompts for the user, wherein the one or more additional prompts have a higher difficulty level than the difficulty level of the initial prompts;
transmitting, via the interactive chatbot, the one or more additional prompts to the user;
receiving additional user input in response to the one or more additional prompts;
determining the risk score of the additional user input;
authenticating the user based upon the user having a risk score for the additional user input above the predetermined threshold; and
declining authenticating the user based upon the user having a risk score for the additional user input below the predetermined threshold.

13. The computer-implemented method of claim 9 further comprising:
generating one or more low difficulty prompts for the user based upon the risk associated with the transaction being low; and
generating one or more high difficulty prompts for the user based upon the risk associated with the transaction being high.

14. The computer-implemented method of claim 9 further comprising:
utilizing at least one of a machine learning algorithm and an artificial intelligence algorithm to generate the one or more prompts for the user, wherein the generated prompts are specific to the user based upon the user data.

15. At least one non-transitory computer-readable storage media that includes computer-executable instructions for authenticating users using an interactive chatbot, wherein when executed by a computing system including at least one processor in communication with at least one memory, the computer-executable instructions cause the at least one processor to:
receive an authorization request message for a transaction initiated by a user, wherein the authorization request message includes transaction data;
retrieve, from the at least one memory, user data associated with the user;
determine, based upon the transaction data and the user data, a risk associated with the transaction;
generate, based upon the risk associated with the transaction, one or more prompts for the user;
transmit, via the interactive chatbot, the one or more prompts to the user;
receive user input in response to the one or more prompts; and
embed an authentication indicator into the authorization request message, wherein the authentication indicator indicates whether the user is authenticated based upon the user input.

16. The at least one non-transitory computer-readable storage media of claim 15, wherein the computer-executable instructions further cause the at least one processor to:
compare the user input and the received user data;
determine, based upon the comparison, a risk score for the user input, wherein the risk score indicates an accuracy level of the user input;
determine, based upon the comparison, an assurance level for the user input, wherein the assurance level indicates an authentication level for the user based upon at least one the risk score and a difficulty level of the one or more prompts; and
embed the assurance level into the authorization request message.

17. The at least one non-transitory computer-readable storage media of claim 16, wherein the computer-executable instructions further cause the at least one processor to:
receive, from one or more issuer computing devices, a predetermined threshold indicating a minimum risk score for the user to be authenticated;
store, in the at least one memory, the predetermined threshold; and
authenticate the user based upon the user having a risk score above the predetermined threshold.

18. The at least one non-transitory computer-readable storage media of claim 17, wherein the computer-executable instructions further cause the at least one processor to:
generate, when the user has a risk score below the predetermined threshold, one or more additional prompts for the user, wherein the one or more additional prompts have a higher difficulty level than the difficulty level of the initial prompts;
transmit, via the interactive chatbot, the one or more additional prompts to the user;
receive additional user input in response to the one or more additional prompts;
determine the risk score of the additional user input;
authenticate the user based upon the user having a risk score for the additional user input above the predetermined threshold; and
decline authenticating the user based upon the user having a risk score for the additional user input below the predetermined threshold.

19. The at least one non-transitory computer-readable storage media of claim 15, wherein the computer-executable instructions further cause the at least one processor to:
generate one or more low difficulty prompts for the user based upon the risk associated with the transaction being low; and
generate one or more high difficulty prompts for the user based upon the risk associated with the transaction being high.

20. The at least one non-transitory computer-readable storage media of claim 15, wherein the computer-executable instructions further cause the at least one processor to:
utilize at least one of a machine learning algorithm and an artificial intelligence algorithm to generate the one or more prompts for the user, wherein the generated prompts are specific to the user based upon the user data.
